(19) United States
(12) Patent Application Publication
(10) Pub. No.: US 2003/0163664 A1
(43) Pub. Date: Aug. 28, 2003

(54) Method and apparatus for updating a distributed program

(76) Inventor: Yasushi Kanda, Kariya-shi (JP)

Correspondence Address: POSZ & BETHARDS, PLC, 11250 ROGER BACON DRIVE, SUITE 10, RESTON, VA, 20190, US

(21) Appl. No.: 10/374,087

(22) Filed: Feb. 27, 2003

(30) Foreign Application Priority Data
Feb. 28, 2002 (JP) 2002-53790

(51) Int. Cl. G06F 12/00

(52) U.S. Cl. 711/202

(57) ABSTRACT

A technique of updating a program stored in a first nonvolatile storage area of a system with another version of the program by using an program updating apparatus. The system includes a second nonvolatile storage area for storing inheritable data that are used in both the program and the new version that may be different from each other in address mapping of the inheritable data. The inheritable data stored in the second nonvolatile storage area are saved in a storage area of the apparatus. The saved inheritable data are sorted such that the sorted saved inheritable data can be used by the another version. And, the sorted saved inheritable data are stored in the second nonvolatile storage area.

### BACKGROUND OF THE INVENTION

1. Field of the Invention

The invention relates to a technique of updating a program stored in a microprocessor-based controller and, more specifically, to such a technique especially used for an electronic control unit installed in a motor vehicle.

2. Description of the Prior Art

As controllers for controlling the engine, the transmission, etc. of motor vehicles, electronic control units (ECUs) are well known and practically used which store a control program (which includes instruction codes and data referred to by the instruction codes) in an electrically rewritable nonvolatile memory such as EEPROM, flash memory, etc. and which enable the control program to be updated even after the purchase of ECU-equipped motor vehicle.

These ECUs with a program updating capability usually controls control objects such as the engine according to the program stored in the electrically rewritable nonvolatile memory. If the ECU judges that an updating condition is satisfied by, for example, receiving an updating command from a program updating apparatus or terminal temporarily connected to the ECU, then the ECU changes it's operation mode into an updating mode and rewrites the program resident in the electrically rewritable nonvolatile memory with a new one received from the program updating apparatus. In this way, such ECUs as mentioned above enables an easy updating in case of a need of changing the way of operation or control.

As is well known ion the art, there are some, in the control data, that a new program should inherit, in the updating process, from the old or current program that has been stored in the electrically rewritable nonvolatile memory. Such control data to be inherited include trained data that have been trained or learned in usual control operation and data such as correction values specific to each vehicle which are set and stored to eliminate the effects due to the difference in hardware at the time of shipment from the factory.

In conventional updating techniques, in order to enable the new program to properly inherit the inheritable control data from the old program, it is necessary not only to preserve the inheritable control data before and after the updating but also to try not to change the memory mapping of the inheritable control data in designing the new program. This disadvantageously disables such a program alteration as involves alteration of storage locations of the inheritable control data.

Therefore, what is needed is a technique of updating a program including inheritable data with a new one while enabling the new program to use the inheritable data properly after the updating without a need of placing any limitation on program alteration (or designing of the new program).

### SUMMARY OF THE INVENTION

According to an aspect of the invention, there is provided a method of updating a program stored in a first nonvolatile storage area of a system with another version of the program by using an apparatus for dedicated to this purpose. The system includes a second nonvolatile storage area for storing inheritable data that are desired to be used in both the program and the new version that are permitted to be different from each other in address mapping of the inheritable data. The system and the apparatus can communicate with each other. In the method, the inheritable data stored in the second nonvolatile storage area are saved in a storage area of the apparatus. The saved inheritable data are sorted such that the sorted saved inheritable data can be used by the another version. And, the sorted saved inheritable data are stored in the second nonvolatile storage area.

According to another aspect of the invention, an apparatus for updating a first version of a program stored in a first nonvolatile storage area of a system (typically, an electronic control unit for a motor vehicle) with a second version of the program is provided. The system includes a second nonvolatile storage area for storing inheritable data that are desired to be used in both the first and the second versions that are permitted to be different from each other in address mapping of the inheritable data. The apparatus comprises means for communicating with the system; means for storing a plurality of versions of the program and memory maps of the second nonvolatile storage area associated with respective versions; means for saving, in a storage area, the inheritable data stored in the second nonvolatile storage area by sending a predetermined command to the system; means for sending the second version to the system; means for sorting the saved inheritable data such that the sorted saved inheritable data can be used by the second version; and means for sending results of the sorting means to the system.

### BRIEF DESCRIPTION OF THE DRAWING

Further objects and advantages of the present invention will be apparent from the following description of the preferred embodiments of the invention as illustrated in the accompanying drawing, in which:

FIG. 1 is a schematic diagram showing an overall configuration of a program updating system according to the invention;

FIGS. 2A through 2C are diagrams showing memory maps of flash ROM 23, RAM 25 and EEPROM 11, respectively, of FIG. 1;

FIG. 3. is diagram showing two examples of various versions of the control program that constitute a program database stored in a program updating apparatus of FIG. 1;

FIG. 4 is a flowchart showing an exemplary operation executed by the CPU 21 of ECU 1 under the control of programs stored in ROM 23;

FIG. 5 is a flowchart showing an exemplary program updating operation executed by the program updating apparatus 3 of FIG. 1; and

FIG. 6 is a diagram illustrating how a virtual memory is used in a updating process.

Throughout the drawing, the same elements when shown in more than one figure are designated by the same reference numerals.

### DETAILED DESCRIPTION OF THE PREFERRED EMBODIMENTS

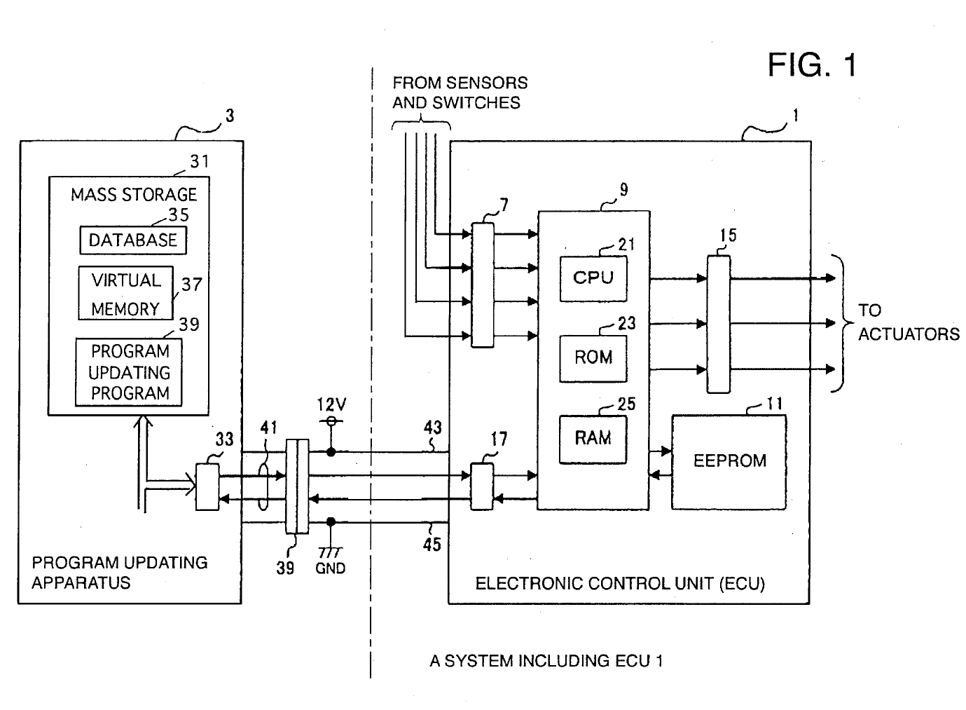

FIG. 1 is a schematic diagram showing an overall configuration of a program updating system according to the invention. The program updating system of FIG. 1 comprises an electronic control unit (ECU) 1 mounted in a motor vehicle (not shown) and used for controlling an engine for example, and a program updating apparatus 3 connected to the ECU 1 in order to update an engine control program installed in the not-shown motor vehicle.

As shown in FIG. 1, the ECU 1 comprises input circuits 7 for receiving signals from various not-shown switches and sensors for detecting operation conditions; a microprocessor-based controller 9 for executing various operations to control the engine (not shown); a electrically erasable programmable read only memory (EEPROM) 11 for storing data for use in the program executed by the controller 9; output circuits 13 for driving actuators 13 such as a fuel injector (not shown), an igniter (not shown) attached to the engine and the like in response to control signals from the controller 9; and a communication interface 17 for communicating data with the program updating apparatus 3.

As is well known in the art, the controller 9 comprises a central processing unit (CPU) 21; a read only memory (ROM) 23 for storing a program (which includes instruction codes constituting the program and data referred to by the instruction codes) executed by the CPU 21; and a random access memory (RAM) 25 for temporarily retaining data used and finally calculated by the CPU 21 during the operation of the CPU 21. As the ROM 23, there is preferably used an electrically erasable or rewritable flash memory. The controller 9 may be realized either by a single-chip microprocessor or by a plurality of integrated circuits. The EEPROM 11 may be included in the controller 9.

The program updating apparatus 3, which may be any suitable microcomputer, includes a mass storage device 31 such as a hard disc, an optical disc, etc. and a communication interface 33 for communicating data with the ECU 1. The ECU 1 and the program updating apparatus 3 are connected with each other through a pair of connectors 39. Specifically, communication interfaces 17 and 33 are interconnected via communication lines 41 thereby to be capable of serial communication with each other. A power supply voltage of 12 V is supplied to both of the ECU 1 and the program updating apparatus 3 via a power feeder line 43 and a ground line 45.

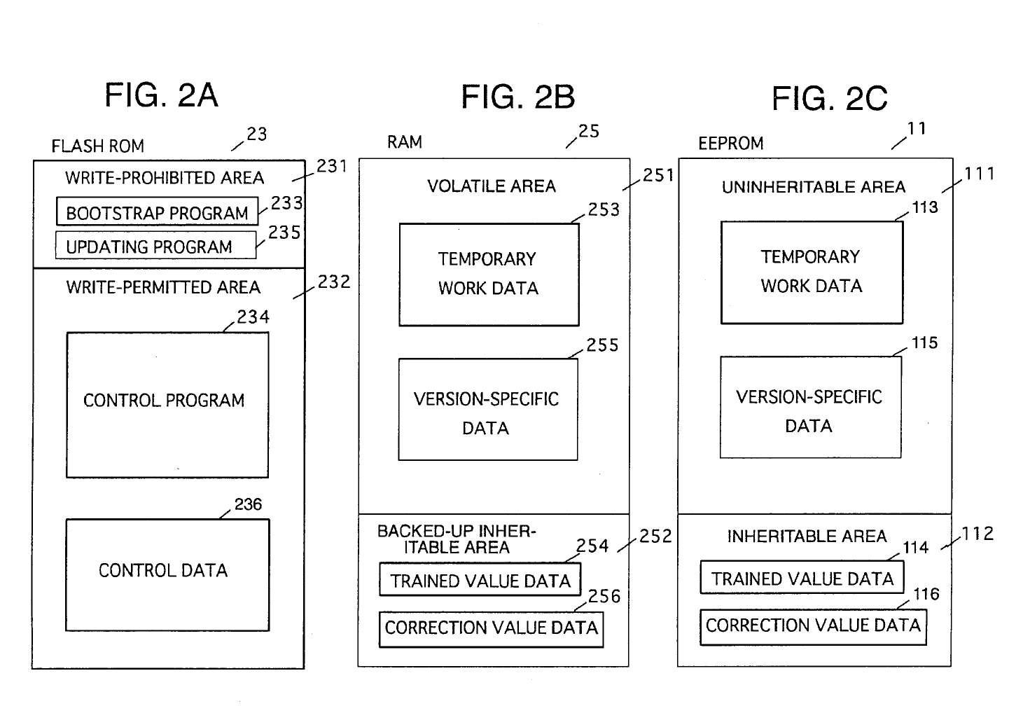

FIGS. 2A through 2C are diagrams showing memory maps of ROM (a flash ROM in this specific example) 23, RAM 25 and EEPROM 11, of the ECU 1 shown in FIG. 1.

In FIG. 2A, the flash ROM 23 is divided into a write-prohibited area 231 in which data rewriting is prohibited and a write-permitted area 232 in which data rewriting is permitted. In the write-permitted area 232, there have been already stored a control program 234 and control data 236 referred to by the control program 234. The control program 234 includes version information indicative of the version thereof. Also, in the write-prohibited area 231, there have been already stored a bootstrap program 233 that is to be executed just after a reset or a power-on and a rewrite processing program 235 for rewriting the program stored in the write-permitted area 232.

In FIG. 2B, the memory space of RAM 25 is divided into a volatile area 251 in which the stored data do not need preserving and a battery backed-up inheritable area 252. In the backed-up inheritable area 252, there are stored data that are desired to be continuously used regardless of the version of the control program 234 stored in the write-permitted area 232 (i.e., data that can be also used in a new version of the control program 234 even after updating). The backed-up inheritable data 254 stored in the battery backed-up area 252 include trained value data 254 and/or correction value data 256 that should be continuously preserved even if the power supply to the ECU 1 is stopped. Also, in the volative area 251, there are stored ordinary data 253 other than the backed-up inheritable data and data (hereinafter, referred to as “the version specific data”) 255 specific to each version of the control program 234 stored in the write permitted area 232. The trained value data 254 are data such as control constants calculated in learning control operation by the program 234 stored in the write permitted area 232 of the flash ROM 23. The correction value data 256 are data that are set and stored to eliminate the effects due to the difference in hardware at the time of shipment of the ECU 1 from the factory and are used in correction operations. Some of the correction value data 256 are updated during learning control operations of the ECU 1.

Similarly, in FIG. 2C, the memory space of the electrically erasable programmable read only memory (EEPROM) 11 is divided into an uninheritable area 111 for storing uninheritable data that need preserving as long as the program version remains unchanged but do not need to be inherited by a new version after updating and an inheritable area 112 for storing inheritable data that are inherited by a new version even after updating. The inheritable data stored in the inheritable area 112 includes trained value data 114 and correction value data 116 other than data stored in the backed-up inheritable area 252 of RAM 25. The uninheritable data stored in the uninheritable area 111 includes temporary work data 113 and version specific data 115 other than those stored in the volatile area 251 of RAM 25.

On the other hand, the program updating apparatus 3 stores, in the mass storage device 31, a database 35 to which the apparatus 3 refers during operation of updating the control program 234 and data 236 of the ECU 1. Also, the mass storage device 31 includes a virtual memory area 37 to which data resident in the backed-up inheritable area 252 of RAM 25 and in the inheritable area 112 of EEPROM 11 are copied prior to an updating operation.

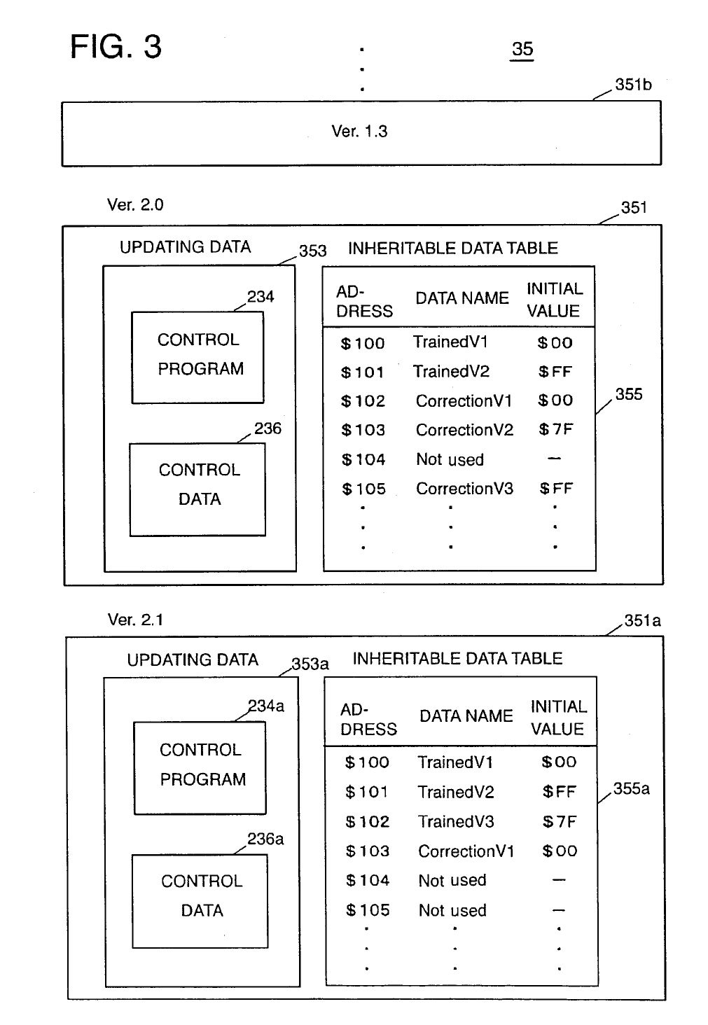

FIG. 3 is diagram showing two examples of updating data sets for various versions of the control program that constitute the program database 35 stored in a program updating apparatus 3 of FIG. 1. By way of example, there are shown three sets 351a, 351 and 351b (listed from the bottom) of updating data for versions 2.1, 2.0 and 1.3, respectively, in FIG. 3. Only the updating data sets 351a and 351 are shown in detail. In the following description, it is assumed that a control program of version 2.0 is currently installed in the ECU 1 of FIG. 1.

Each of the updating data sets comprises updating data 353 and an inheritable data table 355. The updating data 353 comprises a control program 234 and a control data 236 which are to be stored in the write-permitted area 232 of the flash ROM 23 of the ECU 1.

The inheritable data table 355 contains respective records for all the addresses (100, 101, 102, . . . in this specific example) of the battery backed-up inheritable area 252 of RAM 25 and the inheritable area 112 of EEOROM 11. A record for each address contains the address, a data name of the data to be stored in the address, and an initial value for the data. In case of the program of version 2.0 for example, the inheritable data area address “100” contains data labeled “TrainedV1”, which means a trained value 1, and the initial value for the data TrainedV1 is “00” in hexadecimal. In FIG. 3, hexadecimal numbers “nnn” are expressed as “$nnn”. A notation “Not used” in the data name field or column indicates that a program of the version does not access the address (i.e., does not use the data resident in the address). The initial values are determined adaptively to the version in designing the version.

Referring to FIGS. 3 through 6, a program updating operation executed by the ECU 1 and the program updating apparatus 3 will be described in the following. It is assumed that the program of version 2.0 installed in the ECU 1 is updated with the updating data set of version 2.1.

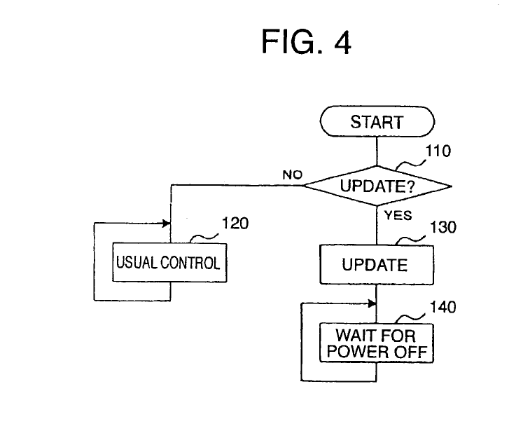

FIG. 4 is a flowchart showing an exemplary operation executed by the CPU 21 of ECU 1 under the control of programs stored in ROM 23. When a power supply voltage is applied to the ECU 1 due to turning on of the system including the ECU 1, the bootstrap program 233 stored in the flash ROM 23 is first executed. In step 110 to make a test to see whether to enter into a program updating mode. This test is made by judging whether a predetermined command is received from the program updating apparatus 3. If not, the CPU 21 starts executing the control program 234 in step 120. In the course of control operation, the control program 234 trains some data and stores them as trained value data 254 and 114 in RAM 25 and EEPROM 11, respectively.

If the CPU 21 determined to enter into the program updating mode in step 110, then CPU 21 starts executing the updating program 235 stored in the write-permitted area 231 of flash ROM 23 in step 130, in which the CPU 21 updates the contents of the write-permitted area 232 of flash ROM 23 with the updating data 353 transmitted from the apparatus 3 as detailed later. Thereafter, the CPU 21 dose no process in step 140 to wait for a turning-off of power. At this stage, the program updating apparatus 3 is disconnected from the ECU 1. If the system that includes the CEU 1 is turned on, then the ECU 1 operates under the control of the updated control program 234 and data 236.

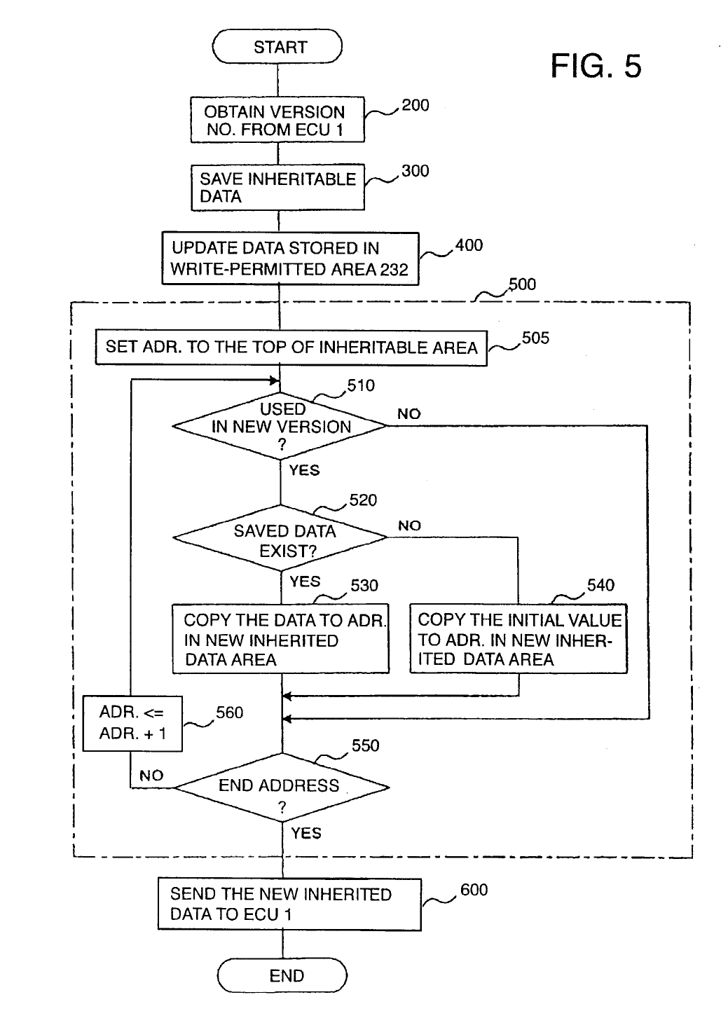

FIG. 5 is a flowchart showing an exemplary program updating operation executed by the program updating apparatus 3 in response to a predetermined command issued by the operator of the apparatus 3. In FIG. 5, step 200 obtains the version number of the current program stored in the write-permitted area 232 of flash ROM 23 by sending a version request command that includes a read address indicative of the address where the version number is stored to the ECU 1. In response to the version request command, the ECU 1 reads and sends the data (i.e., the version number) stored in the read address to the apparatus 3.

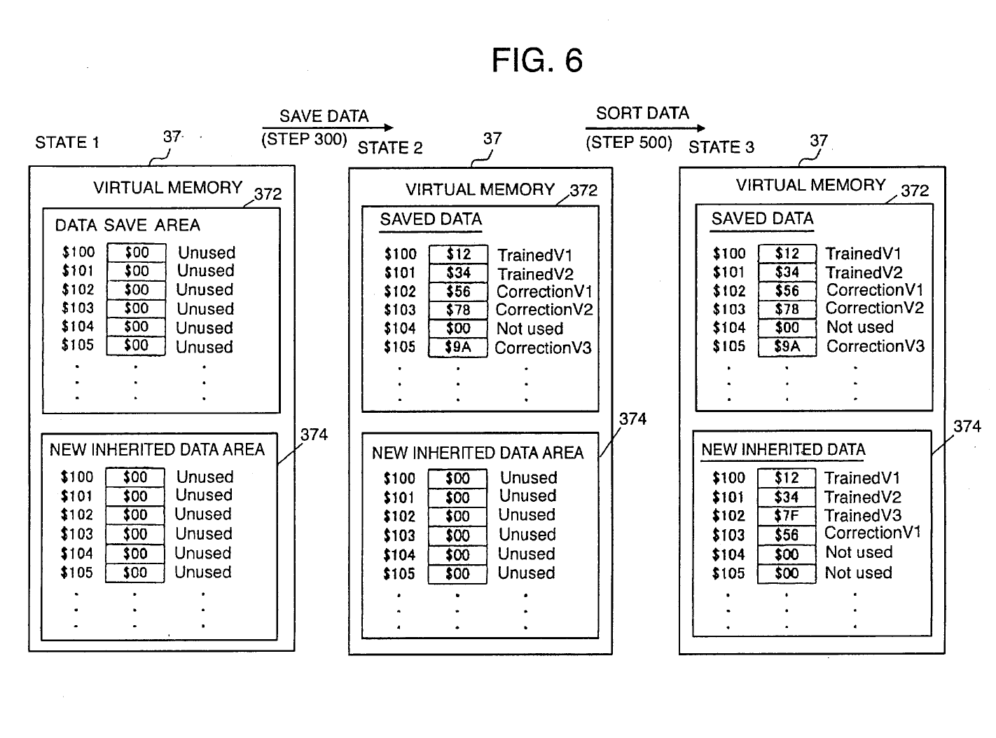

Step 300 saves the inheritable data that are stored in the inheritable data areas 252 and 112 of RAM 25 and EPROM 11, respectively, of the ECU 1 in the data save area 372 of the virtual memory 37 as shown in FIG. 6. Specifically, step 300 reads, from the database 35, the updating data set 351 identified by the version number (=2.0 in this specific example) received from the ECU 1; identifies the addresses used in the version (i.e., the addresses for which respective DATA NAME fields contains values other then “Not used”) and sends a predetermined command and the identified addresses to the ECU 1. Responsively, the ECU 1 returns data stored in only the received addresses of the inheritable data areas 252 and 112 to the program updating apparatus 3. Then, the apparatus 3 saves the received data in respective addresses of the data save area 372 in the virtual memory 37.

As shown in FIG. 6, the virtual memory 37, which is a storage space provided in the mass storage deice 31, is divided into two: i.e., the data save area 372 for storing the inheritable data that have been resident in the areas 112 and 252 of the ECU 1 and a new inherited data area 374 for preparing a new inheritable data for the new version (2.1 in this specific example). The addresses of each of the data save area 372 and new inherited data area 374 are so arranged as to be the same as those in the inheritable data areas 112 and 252. The inheritable data read from the inheritable data areas 112 and 252 of the ECU 1 is written in the same addresses of the data save area 372 in which the inheritable data have been stored in the inheritable data areas 112 and 252 in step 300. In other words, step 300 causes the data save area 372 to change its state from state 1 to state 2 shown in FIG. 6.

Step 400 reads a updating data set of version 2.1 from the database 35 and sends the control program 234a and data 236a with an updating command to the ECU 1, which in turn rewrites the control program 234 and data 236 in the write-permitted area 232 with the received program 234a and data 236a.

Then, step 500 sorts the saved data that have been stored in the data save area 372 in step 300 so as to be adapted to the new version 2.1. Specifically, step 505 sets an address pointer (ADR.) to the start address of the inheritable data area 252 and 112 or the addresses of the inheritable data table 351. Step 510 makes a test to see if the new version 2.1 uses the inheritable data of the address pointed by the address pointer in the inheritable data table 351a for the new version 2.1 (in other words, if any value (or a data name) other then “Not used” is set in the data name field for the pointed address). If not, then the control is passed to step 550.

Step 550 makes a test to see if the pointed address is the end address of the inheritable data area 252 and 112 or the inheritable data table 351. If not, then step 560 increments the address pointer (ADR.) and returns to step 510.

If the inheritable data in the pointed address is to be used by the new version in step 510, then the control is passed to step 520. Step 520 makes another test to see if there is saved inheritable data for the found data name found in step 510. This test is achieved by making a check to see if the found data name is also found in the inheritable data table 355 for the current version 2.0.

If so, then step 530 copies the contents at the address of the data save area 372 which address is associated with the found data name in the inheritable data table 355 for the current version 2.0 to the location of the new inheritable data area 374 pointed by the address pointer.

Taking an address “$103” for example, the operation from step 510 through 530 is described. In step 510, it is seen from the new version (2.1) inheritable data table 351a that the address $103 is used for data named “CorrectionV1”. Also, the data CorrectionV1 is stored in an address $102 in the current version (2.0) as seen from the new version (2.0) inheritable data table 351. Accordingly, the test result is YES in step 520, causing the control to be passed to step 530. Then, it is known that the inheritable data CorrectionV1 to be stored in address $103 in the new version is saved in address $102 of the data save area 372, step 530 copies the data (=$56 in this specific example) stored in address $102 of the data save area 372 to address $103 of the new inherited data area 374. Thus, through a series of steps 510 through 530, the inheritable data CorrectionV1 which is also used in the new version is stored in the new inherited data area 374, having its address converted from address $102 adapted to the current version 2.0 to address $103 adapted to the new version 2.1 by sorting.

If no data has been saved for the found data name (or the found data name cannot be found in the inheritable data table 355 for the current version 2.0) in step 520, then step 540 copies the content of the initial value field associated with the found data name in the inheritable data table 355a for the new version 2.1 to the location of the new inheritable data area 374 pointed by the address pointer.

In case of the address pointer being $102 for example, data TrainedV3 associated with address $102 in the new version inheritable data table 351a is not used in the current version or not found in the current version inheritable data table 351. This results in NO in step 520. Then, step 540 copies the initial value ($7F in this specific example) to address $102 of the new inherited data area 374.

After step 530 or 540, the control is passed to step 550. If the pointed address has not reached the end address of the inheritable data area 252 and 112 or the inheritable data table 351, step 560 increments the address pointer (ADR.) and returns to step 510. Iterating steps 510 through 550 completes the new inheritable data in the new inheritable data area 374 of the virtual memory 37 as shown in state 3 of FIG. 6. If the pointed address has reached the end address in step 550, then the control is passed to step 600.

In step 600, the program updating apparatus 3 sends the new inheritable data of the only addresses in the new inheritable data area 374 which addresses are used in the new version (2.1 in this example) to the ECU 1. Responsively, the ECU 1 stores the received new inheritable data in the corresponding addresses of the inheritable data areas 252 and 112. This completes the program updating operation.

According to the present invention, even if the data mapping has been changed for the inheritable data that are desired to be used in both the current and new versions in design the new version, the inheritable data can be used in the new version after updating the current version with the new one. Since the designer is freed from the data mapping limitation in design process, this facilitates the design of a new version.

Also, if a new version uses a new kind of inheritable data that has not been used in an old version, then the program updating apparatus 3 is so configured as to store an initial value associated with the new kind in the address of the inheritable area 252 or 112 in which the new kind is to be stored. This prevents the ECU 1 from operating on the basis of improper data. Thus, if a new version uses such a new kind of inheritable data, the program updating apparatus 3 can properly operate just after updating with the new version.

It should be noted that step 600 writes data in the only addresses of the inheritable data areas 252 and 112 which addresses are used in the new version. In other words, the addresses of the inheritable data areas 252 and 112 which are not used in the new version are not updated in the updating operation according to the invention and accordingly retain data that had been used in the old version. This feature facilitates changing the version of the control program back to the old version after updating the old version with the new one.

Further, the program updating apparatus 3 saves all the contents of the inheritable data areas 252 and 112 of the ECU 1 in the data save area 372 of the virtual memory 37. This enables a complete restoration of the contents of the inheritable data areas 252 and 112 if it is necessary to change the program of the ECU 1 to the old version. Also, it is possible to examine how the old program actually works by reading the data stored in the virtual memory 37. Further more, even if the data in the inheritable data areas 252 and 112 of the ECU 1 have been disappeared during updating operation, the disappeared data can be completely restored by a new program after updating.

The foregoing merely illustrates the principles of the invention. Thus, various changes and modifications are possible to those skilled in the art.

For example, in step 600, all the data stored in the new inherited data area 374 may be copied as they are to the inheritable data areas 252 and 112 of the ECU 1. In this case, if it is desired that the data of the addresses that are not used in the new version is prevented from being changed, then what has to be done is to copy all the data stored in the inheritable data areas 252 and 112 of the ECU 1 to the data save area 372 of the virtual memory 37 in step 300; and to add, in a path from step 510 to step 550, a step of copying all the data labeled other than “Not used” to the corresponding addresses of the new inherited data area 374.

In the above-described illustrative embodiment, the invention is applied to an electronic control unit for use in a motor vehicle. However, the invention is applicable to any system (referred to as a “target system”) that includes a CPU that operates under the control of a program. In this case, the target system and the program updating apparatus may be connected with any suitable network instead of the connector 39.

Also, in this case, the virtual memory 37 and the program updating program 39 may be provided in the target system. Alternatively, the target system may be provided with the virtual memory 37 and download the program updating program 39, a necessary updating data set 351a and a necessary inheritable data table 355 from the program updating apparatus 3 (or a program server in this specific case).

Many widely different embodiments of the present invention may be constructed without departing from the scope of the present invention. It should be understood that the present invention is not limited to the specific embodiments described in the specification, except as defined in the appended claims.

What is claimed is:

1. A method of updating a program stored in a first nonvolatile storage area of a system with another version of said program by using an apparatus for dedicated to this purpose wherein the system includes a second nonvolatile storage area for storing inheritable data that are desired to be used in both the program and the new version that are permitted to be different from each other in address mapping of the inheritable data and wherein the system and the apparatus can communicate with each other, the method comprising the steps of:
saving, in a storage area of the apparatus, said inheritable data stored in said second nonvolatile storage area;
sorting at least said saved inheritable data such that said sorted saved inheritable data can be used by the another version; and
storing said sorted saved inheritable data in said second nonvolatile storage area.

2. An apparatus for updating a first version of a program stored in a first nonvolatile storage area of a system with a second version of the program wherein the system includes a second nonvolatile storage area for storing inheritable data that are desired to be used in both the first and the second versions that are permitted to be different from each other in address mapping of the inheritable data, the apparatus comprising:
means for communicating with the system;
means for storing a plurality of versions of the program and memory maps of said second nonvolatile storage area associated with respective versions;
means for saving, in a storage area, said inheritable data stored in said second nonvolatile storage area by sending a predetermined command to the system;
means for sending said second version to the system;
means for sorting said saved inheritable data such that said sorted saved inheritable data can be used by the second version; and
means for sending results of said sorting means to the system.

3. An apparatus as defined in claim 2, wherein said storage area has the same addressed assigned thereto as said second nonvolatile storage area and wherein said saving means comprises;
means for sending said predetermined command and only addresses of said second nonvolatile storage area that are used by the first version to the system; and
means for saving received data transmitted from the system in said only addresses of said storage area.

4. An apparatus as defined in claim 3, wherein each of said memory maps includes an initial value for data to be stored in each address in said second nonvolatile storage area, and wherein said sorting means comprises:
means, in the event that a memory map for the second version includes at least one kind of data that are not included in a memory map for the first version, for sorting said saved inheritable data and said initial value(s) associated with said at least one kind such that said sorted inheritable data and initial value(s) can be used by the second version.

5. An apparatus as defined in any of claims 2 through 4, wherein said sorting means includes means for sorting only data of said saved inheritable data that are used in said second version.
